(19) United States
(12) Patent Application Publication
(10) Pub. No.: US 2026/0298309 A1
(43) Pub. Date: Oct. 1, 2026

(54) DAMPER DEVICE

(71) Applicants: NISSAN MOTOR CO., LTD., Yokohama-shi, Kanagawa (JP); EXEDY CORPORATION, Neyagawa-shi, Osaka (JP)

(72) Inventors: Makoto OGATA, Kanagawa (JP); Satoshi YOSHIDA, Kanagawa (JP); Takeshi SENOUE, Neyagawa-shi, Osaka (JP); Yuji FUKUTA, Neyagawa-shi, Osaka (JP); Katsunari KATO, Neyagawa-shi, Osaka (JP)

(73) Assignees: NISSAN MOTOR CO., LTD., Yokohama-shi, Kanagawa (JP); EXEDY CORPORATION, Neyagawa-shi, Osaka (JP)

(21) Appl. No.: 19/479,237

(22) PCT Filed: Mar. 5, 2024
(86) PCT No.: PCT/JP2024/008170

§ 371 Date: Oct. 27, 2025

(30) Foreign Application Priority Data
Apr. 28, 2023 (JP) 2023-073908

(51) Int. Cl. F16F 15/129; F16F 15/123

(52) U.S. Cl. CPC F16F 15/129; F16F 15/123; F16F 2238/04

(57) ABSTRACT

A cylindrical section extends in an axial direction from an inner circumferential edge of a disc section of a bush, and is interposed between an inner circumferential end edge of a retaining plate and an outer peripheral surface of a boss part. Dimensions of the cylindrical section are set so as to limit a deflection angle of a central axis within a prescribed range when the boss part is inclined. When the boss part is inclined during the step for connecting to a gear box, the cylindrical section is sandwiched between the inner circumferential end edge of the retaining plate and the boss part, thereby limiting the deflection angle of the central axis. Dimensions of a claw section are set such that a bending stress with the maximum deflection angle does not cause breakage.

### TECHNICAL FIELD

The present invention relates to a damper device, which is arranged, for example, between an engine (internal combustion engine) and a transmission.

### BACKGROUND ART

In many cases, an automobile includes a damper device arranged between an engine and a transmission to transmit a torque while absorbing and damping torsional vibrations. A patent document 1 discloses such a damper device, which includes: an input side rotor to which a torque is inputted from an engine; an output side rotor that is combined with the input side rotor and arranged rotatably with respect to the input side rotor; and coil springs arranged between the input side rotor and the output side rotor, wherein each of the coil springs extends along a rotational tangential direction.

The damper device disclosed in patent document 1 further includes a friction-producing mechanism structured to produce a frictional torque in response to relative rotation between the input side rotor and the output side rotor. The friction-producing mechanism includes: a spline hub serving as the output side rotor; a bushing in sliding contact with the spline hub; and an annular conical spring biasing the bushing in an axial direction. The bushing includes claw portions that protrude radially outwardly. Each of the claw portions engages with a recess of a second bushing of a second friction-producing mechanism radially outside the claw portion, thereby positioning the bushing with respect to the input side rotor in a rotational direction.

For example, when an input shaft of the transmission is inserted into the spline hub during assembling of the engine and the transmission, the input shaft of the transmission may be inclined with respect to the spline hub. The inclination in central axis of the output side rotor with respect to the input side rotor may cause the bushing to incline together with the spline hub, so that a tip end of each claw portion positioned radially outside may be pushed in the axial direction by the second bushing, and the claw portion may be thereby broken at its base.

### PRIOR ART DOCUMENT(S)

### Patent Document(s)

Patent Document 1: Japanese Patent Application Publication No. 2003-074636

### SUMMARY OF INVENTION

According to the present invention, a damper device includes: a first rotor; a second rotor arranged to rotate with respect to the first rotor, wherein the second rotor includes a boss part at a center of the second rotor; a spring member connecting the first rotor and the second rotor elastically in a rotational direction; and a friction-producing mechanism structured to produce a frictional torque in response to relative rotation between the first rotor and the second rotor; wherein the friction-producing mechanism includes: a bushing having an annular shape, and fitted on an outer periphery of the boss part, and arranged to rotate with respect to the boss part, wherein the bushing has an end surface in contact with an annular friction surface of the second rotor; a retaining plate of the first rotor, wherein the retaining plate faces the bushing in an axial direction; and a conical spring having an annular shape, and arranged in a compressed state between the bushing and the retaining plate to bias the bushing toward the annular friction surface; wherein the bushing includes: a disc portion located between the annular friction surface and the conical spring; a tubular portion extending in the axial direction from an inner periphery of the disc portion and between the outer periphery of the boss part and an inner periphery of the retaining plate; and claw portions each of which protrudes radially outwardly from a corresponding one of locations of an outer periphery of the disc portion; wherein each of the claw portions engages with an engagement recess formed in an annular member that rotates integrally with the first rotor; and wherein the tubular portion is structured to limit an angle of deviation of a central axis of the boss part with respect to a central axis of the first rotor so as to prevent the claw portions from being broken due to a bending stress, by being sandwiched between the inner periphery of the retaining plate and the boss part in response to inclination of the central axis of the boss part with respect to the central axis of the first rotor.

According to this invention, even when the central axis of the boss part is inclined with respect to the central axis of the first rotor due to an external force, for example, during assembly, the angle of deviation is limited in magnitude, thereby preventing breakage of the claw portions.

### BRIEF DESCRIPTION OF DRAWINGS

FIG. 1 is a cross-sectional view of a major part of a damper device according to an embodiment.

FIG. 2 is an enlarged cross-sectional view of a part of FIG. 1 including a bushing.

FIG. 3 is a plan view of the bushing as shown separately.

FIG. 4 is a cross-sectional view taken along a line A-A in FIG. 3.

FIG. 5 is an explanatory diagram illustrating a state in which a hub member is inclined during an operation of connecting an engine and a gearbox.

### MODE(S) FOR CARRYING OUT INVENTION

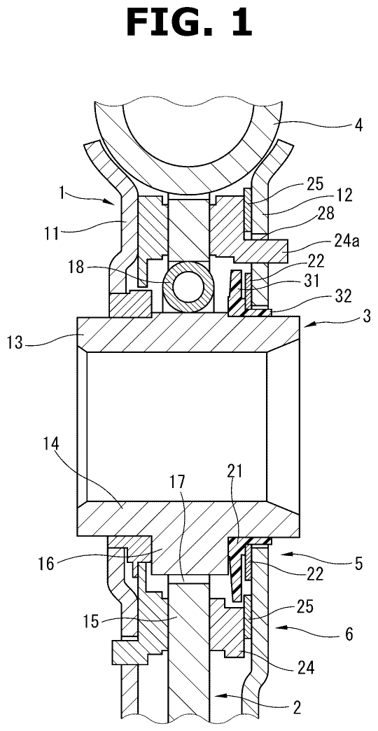

The following describes an embodiment of the present invention with reference to the drawings. In the following, an outline of a damper device is described briefly, because it is publicly known as disclosed in patent document 1. For example, the damper device includes: an input side rotor 1 that is attached to a flywheel at a rear end of an engine and receives input of an engine torque; and an output side rotor 2 that is combined with the input side rotor 1 and arranged rotatably with respect to the input side rotor 1. In this example, the output side rotor 2 includes a splined hub 3 as a main component, wherein an input shaft of a gear box to be connected to the engine is splined to the splined hub 3. In FIG. 1, the left side is an engine side, and the right side is a gearbox side.

In the illustrated example, the engine functions as an electric generator in a series hybrid vehicle, wherein a rotation speed from the engine is increased at the gearbox to drive a motor generator connected to the gearbox.

The input side rotor 1 is formed in a disc shape by joining an outer periphery of an input plate 11 and an outer periphery of a retaining plate 12, wherein the input plate 11 has a substantially circular shape and is located on the engine side, and wherein the retaining plate 12 has a substantially circular shape and is located on the gearbox side. The spline hub 3, which forms the output side rotor 2, is sandwiched between the input plate 11 and the retaining plate 12. For elastic coupling thereof in a rotational direction, a plurality of coil springs 4, for example, four coil springs 4, are arranged wherein each coil spring extends along a rotational tangential direction. The coil springs 4 produce elastic forces to absorb torsional vibrations.

In the illustrated example, similarly as disclosed in JP 2022-095172 A, the spline hub 3 is composed of separate parts, i.e., a central hub member 13 and an outer flange member 15, wherein the central hub member 13 includes a cylindrical boss part 14. The hub member 13 and the flange member 15 are combined by meshing of teeth not shown so as to rotate with respect to each other by a predetermined small angle. Between the hub member 13 and the flange member 15, an auxiliary coil spring 18 is arranged to extend along a rotational tangential direction. Specifically, the hub member 13 has a boss flange 16 near the center in the axial direction. The boss flange 16 protrudes outwardly from the outer periphery of the boss part 14. The boss flange 16 has an outer periphery formed with the teeth described above. The flange member 15 has an opening portion 17 through which the boss flange 16 passes. The opening portion 17 has an inner periphery formed with teeth corresponding to the teeth of the boss flange 16. Between the teeth of the boss flange 16 and the teeth of the opening portion 17 in meshing with each other, a small gap is formed in the rotational direction, wherein the boss flange 16 and the opening portion 17 are biased relatively in the rotational direction by the auxiliary coil spring 18. With this structure, minute torque fluctuations are absorbed in the spline hub 3.

The four coil springs 4 for elastically connecting the input side rotor 1 and the output side rotor 2 are interposed between the input side rotor 1 and the radially outside flange member 15 of the spline hub 3.

The present invention may be applied to a damper device in which a spline hub 3 is composed of a hub member 13 and a flange member 15 that are not separated from each other.

In the illustrated example, the damper device includes a first friction-producing mechanism 5 and a second friction-producing mechanism 6 for producing a frictional torque that acts as a damping force against relative rotation between the input side rotor 1 and the output side rotor 2. The first friction-producing mechanism 5 functions between the input side rotor 1 and the hub member 13 of the spline hub 3. The second friction-producing mechanism 6 functions between the input side rotor 1 and the flange member 15 of the spline hub 3. Both axial sides (the engine side and the gearbox side) of the spline hub 3 are each provided with the first friction-producing mechanism 5 and the second friction-producing mechanism 6. However, the following description focuses on configuration of the friction-producing mechanisms 5 and 6 on the gearbox side as a major part of the present invention. Description of the friction-producing mechanisms on the engine side is omitted.

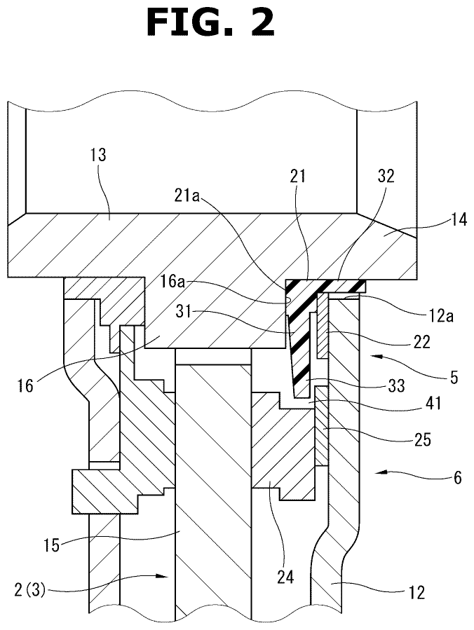

As shown also in FIG. 2, the first friction-producing mechanism 5 is composed of: an annular bushing 21 made of a hard synthetic resin such as a so-called engineering plastic; and an annular conical spring 22 arranged in a compressed state between the bushing 21 and the retaining plate 12.

The bushing 21 is rotatably fitted on the outer peripheral surface of the boss part 14 of the hub member 13 of the spline hub 3. The bushing 21 has an axial end face having an annular friction surface 21a in contact with an annular friction surface 16a of an axial end face of the boss flange 16 of the hub member 13. When the input side rotor 1 and the output side rotor 2 (hub member 13) rotate with respect to each other, sliding contact between the annular friction surface 21a and the annular friction surface 16a produces a frictional torque.

As shown in FIG. 2, the bushing 21 includes: a disc portion 31 located between the boss flange 16 and the conical spring 25; and a cylindrical tubular portion 32 extending from the inner periphery of the disc portion 31 toward the gearbox. Accordingly, the bushing 21 has a substantially L-shaped cross section as a whole. The conical spring 7 is fitted on the outer periphery of the tubular portion 32 and is positioned in the radial direction by the tubular portion 32.

The retaining plate 12 has an inner peripheral portion facing the bushing 21 in the axial direction, wherein the conical spring 22 is disposed therebetween. The retaining plate 12 has an inner periphery 12a located slightly outer than the tubular portion 32 of the bushing 21, wherein the inner periphery 12a and the tubular portion 32 overlap with each other in the axial direction.

The conical spring 22 has a tapered cross section that is inclined at a relatively small angle with respect to a plane perpendicular to the axial direction. Due to this inclination of the cross section, the inner periphery of the conical spring 22 is pressed against the bushing 21 in the axial direction, and the outer periphery of the conical spring 22 is pressed against the inner face of the retaining plate 12 in the axial direction. The conical spring 22 biases the bushing 21 in the axial direction toward the boss flange 16, and thereby brings the annular friction surfaces 21a, 16a into suitable pressure contact with each other.

The second friction-producing mechanism 6 is located radially outside the first friction-producing mechanism 5, and is composed of: a second bushing 24 made of a hard synthetic resin; and a second annular conical spring 25 arranged in a compressed state between the second bushing 24 and the retaining plate 12. The second bushing 24 has a surface to which a suitable lining not shown is attached, wherein the surface faces the flange member 15. The second bushing 24 is in contact with the end face of the flange member 15 via this lining. The second bushing 24 is biased toward the flange member 15 by the second conical spring 25. The biasing force of the second conical spring 25 produces a suitable frictional torque between the second bushing 24 and the flange member 15.

The second bushing 24 has a back face including a protrusion 24a that engages with an opening 28 of the retaining plate 12. Accordingly, the second bushing 24 is capable of moving in the axial direction with respect to the retaining plate 12, but is restricted in movement in the rotational direction (circumferential direction). Namely, the engagement of the protrusion 24a allows the retaining plate 12 and the second bushing 24 to rotate together as a solid unit.

The bushing 21 of the first friction-producing mechanism 5 has a claw portion 33 extending radially outwardly from the outer periphery of the disc portion 31.

The claw portion 33 engages with an engagement recess 41 formed in the back face of the second bushing 24. This engagement restricts rotation of the bushing 21 with respect to the second bushing 24, which in turn restricts rotation of the bushing 21 with respect to the retaining plate 12.

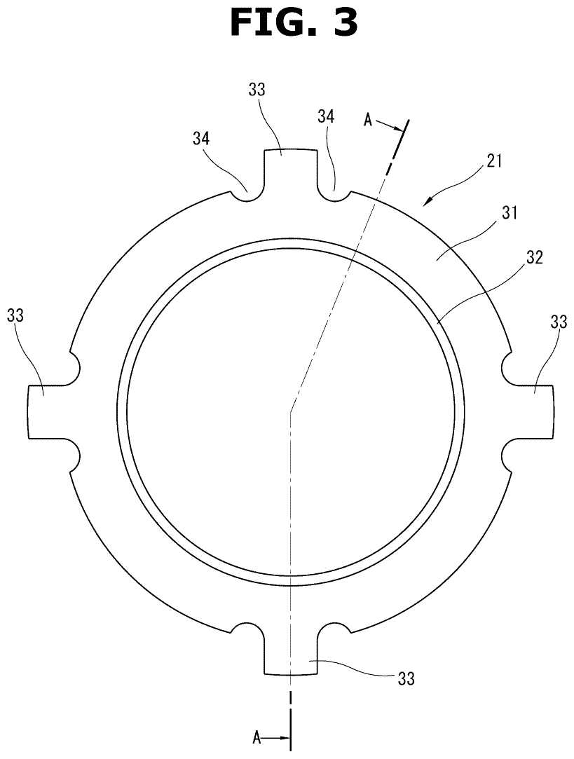

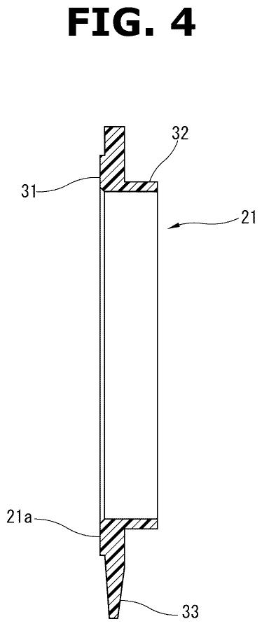

FIG. 3 is a plan view of the bushing 21 from the retaining plate 12 side. FIG. 4 is a cross-sectional view taken along a line A-A in FIG. 3. FIG. 1 corresponds to this cross-sectional view taken along the line A-A. As described above, the bushing 21 includes: the disc portion 31 located between the boss flange 16 and the conical spring 25; the tubular portion 32 extending in the axial direction from the inner periphery of the disc portion 31; and the claw portions 33 protruding radially outwardly from corresponding locations of the outer periphery of the disc portion 31. These components are molded integrally from a hard synthetic resin.

In the present embodiment, four claw portions 33 are provided at corresponding four locations at intervals of an angle of 90° as shown in FIG. 3. Each claw portion 33 has a rectangular shape in the plan view of FIG. 3. Adjacent to each side of each claw portion 33, a substantially semicircular recess 34 is formed in the outer periphery of the disc portion 31 to extend radially inwardly. The provision of the pair of recesses 34 on both sides of each claw portion 33, serves to reduce a stress concentration at a base portion of the claw portion 33 when the tip of the claw portion 33 is pressed in the axial direction.

Furthermore, as shown in FIG. 4, each claw portion 33 has thickness in the axial direction which is smaller at the tip end portion on the radially outer side than at the base portion. Namely, each claw portion 33 has a cross-sectional shape that gets thinner gradually from the radially inner side to the radially outer side. In other words, the axial thickness of the tip portion of the claw portion 33 is smaller than that of the disc portion 31. The thickness of each claw portion 33 may be set to vary stepwise in several steps. As shown in FIG. 4, the radially outer tip of the claw portion 33 is positioned apart from a plane along the annular friction surface 21a of the disc portion 31 toward the retaining plate 12.

Furthermore, the length of the claw portion 33 in the radial direction is set as short as possible within a range that allows the bushing 21 to be positioned in the rotational direction.

As also shown in FIG. 2, the tubular portion 32 of the bushing 21 extends in the axial direction from the inner periphery of the disc portion 31 toward the gearbox, and extends between the inner periphery 12a of the retaining plate 12 and the outer periphery of the boss part 14. The tubular portion 32 is formed to have dimensions such as to limit inclination of the boss part 14, i.e. an angle of deviation of a central axis (center line) of the boss part 14 with respect to a central axis (center line) of the input side rotor 1 when the boss part 14 is inclined during assembly of the engine and the gearbox.

Specifically, the engine and the gearbox are completely assembled with their central axes aligned in a straight line. When in the completed state, the tubular portion 32 is out of contact with the inner periphery 12a of the retaining plate 12. Namely, as shown in FIG. 2, a minute gap exists between the outer periphery of the tubular portion 32 and the inner periphery 12a of the retaining plate 12.

However, during the operation of assembling the engine and the gearbox, particularly when the end of the input shaft on the gearbox side, which is formed with splines, is inserted into the boss part 14 of the hub member 13 for spline connection, the input shaft may be pushed into the boss part 14 when in a slightly inclined state. Furthermore, gearboxes for series hybrid vehicles are smaller in size and shorter in overall length than typical transmissions for vehicle driving, so that such a gearbox can be manually assembled onto an engine by workers. Therefore, it is likely to occur that a worker attempts to insert the input shat at an angle. In such a situation, the boss part 14 (hub member 13) inclines temporarily as insertion of the input shaft progresses. As a result, the bushing 21 fitted on the boss part 14 is inclined with respect to the second bushing 24, and the tip portion of the claw portion 33 interferes with the bottom face of the engagement recess 41. This causes a stress at the base portion of the claw portion 33 and may thereby break the claw portion 33. In particular, in the configuration according to the above embodiment that the spline hub 3 is composed of separated parts, namely, the hub member 13 at the center and the flange member 15 radially outside the hub member 13, the hub member 13 having the boss part 14 is prone to incline solely.

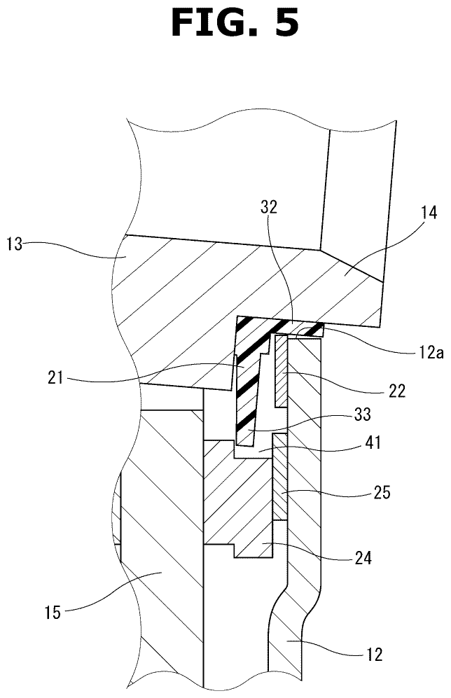

According to the above embodiment, in order to avoid such breakage of the claw portion 33, the tubular portion 32 serves to limit the maximum deviation angle of the central axis to a certain value. FIG. 5 is an explanatory diagram illustrating a state in which the hub member 13 is temporarily inclined during the operation of connecting the engine and the gearbox. This corresponds to a state in which the input shaft on the gearbox side is slightly inserted into the spline hole of the boss part 14. As shown in FIG. 5, when the central axis of the hub member 13 is inclined with respect to the central axis of the input side rotor 1, the tubular portion 32 interposed between the inner periphery 12a of the retaining plate 12 and the outer periphery of the boss part 14 is sandwiched therebetween. Since the tubular portion 32 is made of a sufficiently hard material, the sandwiching of the tubular portion 32 serves to ensure a distance between the inner periphery 12a of the retaining plate 12 and the outer periphery of the boss part 14. This serves to limit the deviation angle of the central axis of the hub member 13.

On the other hand, the claw portion 33 is set to have dimensions and positional relationship such that no bending stress leading to breakage occurs under the maximum deviation angle thus defined by the tubular portion 32. For example, as described above, the tip portion of the claw portion 33 is thin-walled and is apart from the plane along the annular friction surface 21a of the disc portion 31 toward the retaining plate 12. This serves to prevent interference with the bottom face of the engagement recess 41 when the bushing 21 is inclined with respect to the second bushing 24 as shown in FIG. 5. Similarly, the feature that the radial length of the claw portion 33 is short, serves to suppress interference with the bottom face of the engagement recess 41. Furthermore, the feature that the base portion of the claw portion 33 that is continuous with the disc portion 31 is formed to be sufficiently thick whereas the tip portion of the claw portion 33 is thin, serves to suppress breakage of the claw portion 33 even when pressed by the bottom face of the engagement recess 41.

Therefore, even when the gearbox is manually connected to the engine by a worker while being slightly inclined, the claw portions 33 of the bushing 21 can be reliably prevented from breaking. The inclination of the hub member 13 is a phenomenon that occurs temporarily during the assembly process. Once the engine and a housing of the gearbox are firmly fixed together, it will return to the normal state as shown in FIG. 2.

Although one embodiment of the present invention has been described in detail, the present invention is not limited to the above embodiment but may be variously modified. For example, the damper device according to the present invention is not limited to gearboxes for series hybrid vehicles, but may also be applied to configurations in which an input shaft of a transmission is connected to a boss part in a vehicle that is driven by an engine output, and may also be configured such that the damper device is attached to a clutch disc, as in a manual transmission. Furthermore, a component other than the second bushing 24 may be provided with an engagement recess with which the claw portion of the bushing engages. Furthermore, as described above, the spline hub 3 may be of a type that the hub member 13 and the flange member 15 are not separated from each other.

1. A damper device comprising:
a first rotor;
a second rotor arranged to rotate with respect to the first rotor, wherein the second rotor includes a boss part at a center of the second rotor;
a spring member connecting the first rotor and the second rotor elastically in a rotational direction; and
a friction-producing mechanism structured to produce a frictional torque in response to relative rotation between the first rotor and the second rotor;
wherein the friction-producing mechanism includes:
a bushing having an annular shape, and fitted on an outer periphery of the boss part, and arranged to rotate with respect to the boss part, wherein the bushing has an end surface in contact with an annular friction surface of the second rotor;
a retaining plate of the first rotor, wherein the retaining plate faces the bushing in an axial direction; and
a conical spring having an annular shape, and arranged in a compressed state between the bushing and the retaining plate to bias the bushing toward the annular friction surface;
wherein the bushing includes:
a disc portion located between the annular friction surface and the conical spring;
a tubular portion extending in the axial direction from an inner periphery of the disc portion and between the outer periphery of the boss part and an inner periphery of the retaining plate; and
claw portions each of which protrudes radially outwardly from a corresponding one of locations of an outer periphery of the disc portion;
wherein each of the claw portions engages with an engagement recess formed in an annular member that rotates integrally with the first rotor; and
wherein the tubular portion is structured to limit an angle of deviation of a central axis of the boss part with respect to a central axis of the first rotor so as to prevent the claw portions from being broken due to a bending stress, by being sandwiched between the inner periphery of the retaining plate and the boss part in response to inclination of the central axis of the boss part with respect to the central axis of the first rotor.

2. The damper device as claimed in claim 1, wherein the friction-producing mechanism is a first friction-producing mechanism, the bushing is a first bushing, and the annular member is a second bushing of a second friction-producing mechanism arranged radially outside the first friction-producing mechanism.

3. The damper device as claimed in claim 1, wherein the disc portion, the tubular portion, and the claw portions of the bushing are integrally formed of a hard synthetic resin.

4. The damper device as claimed in claim 1, wherein:
the first rotor is attached to a flywheel at a rear end of an engine;
the second rotor includes a splined hub having splines formed in an inner periphery of the boss part; and
the boss part is structured to receive insertion of an input shaft of a gearbox to be connected to the rear end of the engine.

5. The damper device as claimed in claim 1, wherein each of the claw portions is formed to have a base portion and a radially outer tip portion such that the radially outer tip portion is smaller in thickness in the axial direction than the base portion.

6. The damper device as claimed in claim 1, wherein the claw portions are short in radial length so as to prevent the claw portions from being broken when the angle of deviation is maximized under the limitation by the tubular portion.

7. The damper device as claimed in claim 1, wherein the outer periphery of the disc portion includes a recess adjacent to one of the claw portions, wherein the recess extends radially inwardly.
